(19) United States
(12) Patent Application Publication
(10) Pub. No.: US 2008/0155389 A1
(43) Pub. Date: Jun. 26, 2008

(54) MOBILE TERMINAL AND METHOD FOR PROVIDING HYPERLINK INFORMATION

(76) Inventor: Young-Bae SUH, Suwon-si (KR)

Correspondence Address: THE FARRELL LAW FIRM, P.C., 333 EARLE OVINGTON BOULEVARD, SUITE 701, UNIONDALE, NY, 11553, US

(21) Appl. No.: 11/962,997

(22) Filed: Dec. 21, 2007

(30) Foreign Application Priority Data
Dec. 21, 2006 (KR) 131808/2006

(51) Int. Cl. G06F 17/00

(52) U.S. Cl. 715/207

(57) ABSTRACT

A method for providing hyperlink information in a wireless Internet-enabled mobile terminal is provided, in which the mobile terminal detects hyperlink tags including access information from an Hyper Text Markup Language (HTML) source forming a Web page when accessing a wireless Internet, extracts access information from each of the detected hyperlink tags, generates a hyperlink list with the extracted access information, and displays the hyperlink list a display with the Web page displayed.

### PRIORITY

This application claims priority under 35 U.S.C. § 119(a) to a Korean Patent Application filed in the Korean Intellectual Property Office on Dec. 21, 2006 and assigned Serial No. 2006-131808, the disclosure of which is incorporated herein by reference.

### BACKGROUND OF THE INVENTION

1. Field of the Invention

The present invention generally relates to a mobile terminal, and in particular, to a method for providing hyperlink information in a Web page in the wireless Internet.

2. Description of the Related Art

In general, a web page contains many hyperlinks. Due to a limited display size, a conventional mobile terminal does not give a full view of a Web page.

Therefore, to search for intended information by wireless Internet service, a user scrolls up/down to a related hyperlink by pressing directional keys a plurality of times. When the user wants to view a web page linked to the hyperlink, he moves a cursor over the hyperlink and presses an “OK” key.

Even though the user knows the desired hyperlink, the movement to the Web page requires a plurality of key inputs, thereby taking much time. Since Web pages are invoked mostly via hyperlinks, this problem occurs repeatedly during Internet browsing.

When a Web page was created in JavaScript, a mobile terminal that is not equipped with a JavaScript application cannot implement JavaScript functionality. Then it is impossible to select a hyperlink simply by moving the cursor on the Web page. In the case where there exists a hyperlink displayed on a Web page, the user cannot select the hyperlink.

As described above, in order to move to a hyperlink on a Web page in the wireless Internet, the user has to search for the hyperlink, move the cursor over the hyperlink, and press the “OK” key. However, the scroll up/down and cursor movement are very inconvenient because the mobile terminals is not provided with a free pointer such as a mouse used in a desktop computer. Accordingly, there exists a need for developing a function that facilitates a user to select an intended hyperlink in a Web page for a mobile terminal.

### SUMMARY OF THE INVENTION

An aspect of the present invention is to address at least the problems and/or disadvantages and to provide at least the advantages described below. Accordingly, one aspect of the present invention is to provide a mobile terminal for providing hyperlink information so that a user can easily select a hyperlink, and a method therefor.

According to an aspect of the present invention, there is provided a method for providing hyperlink information in a wireless Internet-enabled mobile terminal. The mobile terminal detects hyperlink tags including access information from an HTML source forming a Web page when accessing a wireless Internet; extracts access information from each of the detected hyperlink tags; generates a hyperlink list with the extracted access information; and displays the hyperlink list a display with the Web page displayed.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 is a block diagram of a mobile terminal according to the present invention;

FIG. 2 illustrates a software configuration for implementing a function for providing hyperlink information according to the present invention;

FIG. 3 is a flowchart illustrating a control process for providing hyperlink information according to the present invention; and

FIG. 4 illustrates an exemplary view of a screen of a mobile terminal with a hyperlink list displayed thereon according to the present invention.

### DETAILED DESCRIPTION OF PREFERRED EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides a method for providing hyperlink information in a wireless Internet-enabled mobile terminal. The mobile terminal accesses the wireless Internet. Upon receipt of a Hyper Text Markup Language (HTML) source that forms a Web page, the mobile terminal detects hyperlink tags from the HTML source, extracts access information from the hyper link tags, and generates a hyperlink list with the access information. Also, the mobile terminal displays the hyperlink list on a screen with the Web page displayed thereon. Therefore, the mobile terminal enables a user to fast and easily move to an intended Uniform Resource Locator (URL) in a Web page with hyperlinks.

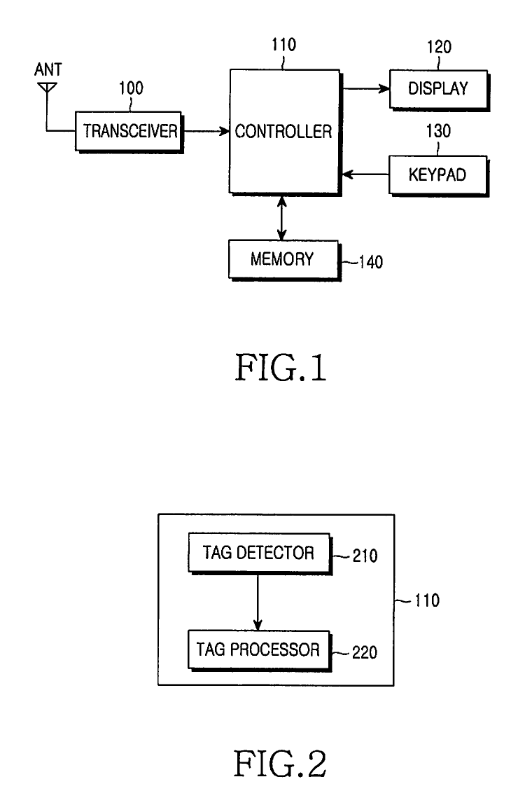

FIG. 1 is a block diagram of a mobile terminal according to an exemplary embodiment of the present invention.

In FIG. 1, the mobile terminal includes a transceiver 100, a controller 110, a display 120, a keypad 130, and a memory 140.

The transceiver 100 performs the wireless communication functionality of the mobile terminal. The transceiver 100 receives an HTML source in the wireless Internet.

The controller 110 includes a software application for selecting hyperlinks from the HTML source. The controller 110 detects the hyperlink tags from the HTML source by the software application and extracts access information from the hyperlink tags. The access information includes a URL, a title, and a Web page format (hereinafter, URL format) determined according to the URL.

The controller 110 then creates a hyperlink list with the access information. Upon key input for selecting a hyperlink from a user, the controller 110 accesses the URL corresponding to the selected hyperlink and displays a Web page at the URL on the display 120.

In this manner, the controller 110 outputs the hyperlink list regarding the current received HTML source, so that the user can easily move to a Web page using the hyperlink list over the wireless Internet.

The display 120 displays the hyperlink list under the control of the controller 110. The keypad 130 has alphanumerical keys for inputting digits and characters, a wireless Internet key, directional keys (up/down/right/left) for selecting a hyperlink in the HTML source, and other keys for invoking functions.

The memory 140 stores information required for controlling the operation of the mobile terminal and the hyperlink list with the access information about the hyperlink tags, i.e. titles, URLs, and URL formats. According to an exemplary embodiment of the present invention, the memory 140 may not store the access information about the hyperlink tags.

FIG. 2 illustrates a software configuration for implementing a function for providing hyperlink information according to an exemplary embodiment of the present invention. The software application of the present invention is a kind of a control program that is run in the controller 110. Moreover, the software application is included in the controller 110 as described below.

In FIG. 2, the controller 110 has a software application with a tag detector 210 and a tag processor 220. The tag detector 210 is a module for detecting hyperlink tags from the HTML source of a current Web page. In addition, the tag detector 210 can detect hyperlink tags used in JavaScript and hyperlink tags that are hidden in the display 120.

The tag processor 220 separates titles and URLs from the hyperlink tags. For example, if a hyperlink tag such as <a href=“www.samsung.co.kr” title=Samsung″> is detected, the tag processor 220 separates a value of the ‘href’ attribute specifying a URL from a value of a title attribute that provides information about the hyperlink in the <a> tag. That is, the tag processor 220 stores the URL “www.samsung.co.kr” and the title “Samsung” in a table in the memory 140. If the hyperlink tag does not include a title attribute, the tag processor 220 checks whether it includes an Alt attribute describing an image file. In the presence of the Alt attribute, the tag processor 220 considers a value of the Alt attribute to be the title value. If either the title attribute or the Alt attribute is not present, the tag processor 220 determines that the URL is the title value.

The tag processor 220 also determines the format of the URL by checking the extension of the URL. If the URL ends with an extension such as html, asp, php, or jsp, the tag processor 220 determines the URL format to be “Web page”. If the extension is bmp, jpg, or gif, the tag processor 220 determines the URL format to be “image.” If the extension is wmv, asf, or mpeg, the tag processor 220 determines the URL format to be “multimedia”. In this manner, the tag processor 220 stores the titles, the URLs, and the URL types in the form of a table.

By the above-described software application, the controller 110 detects hyperlink tags from an HTML source received from the transceiver 100 and extracts access information from the hyperlink tags. That is, the controller 110 separates titles and URLs from the hyperlink tags, determines the formats of the URLs, and tabulates the titles, URLs, and URL formats. Then the controller 110 outputs the list of the titles and the URLs in correspondence with tabs specifying the URL formats.

The above operation is repeated each time the controller 110 receives a new HTML source.

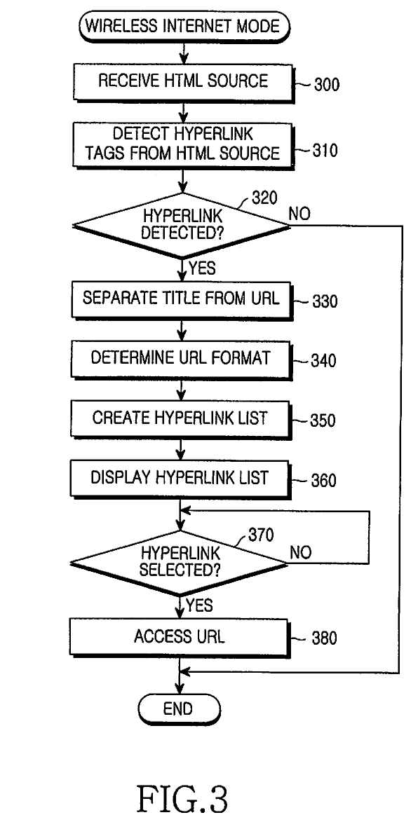

FIG. 3 is a flowchart illustrating a control process for providing hyperlink information according to an exemplary embodiment of the present invention.

In FIG. 3, the controller 110 receives an HTML source that forms a Web page in wireless Internet mode in step 300 and detects hyperlink tags from the HTML source in step 310. A major tag that creates a hyperlink is the <a> tag.

If JavaScript is used for the HTML source, the controller 110 determines whether a JavaScript hyperlink exists in the HTML source. Also, the controller 110 determines whether there is a hyperlink tag with a hidden attribute For example, in the presence of a menu with the hidden attribute in a menu using a Layer tag, the controller 110 can detect a hyperlink included in the layer having the menu with the hidden attribute.

In step 320, the controller 110 determines whether any hyperlink tag has been detected. In the absence of any hyperlink tag, the controller 110 ends the process of FIG. 3 because there is no procedure for providing hyperlink information.

In the presence of a hyperlink tag, the controller 110 separates the hyperlink tag into a title and a URL in step 330 and determines whether the format of the URL is Web page, multimedia, image, or e-mail in step 340. If the URL is not classified into any format, the controller 110 classifies the URL format as ‘others’. Other URL formats can be specified according to an exemplary embodiment of the present invention.

In step 350, the controller 110 creates and stores the title, the URL, and the URL format in the form of a table in the memory 140.

If the tag detector 210 has detected a hyperlink tag such as <a href=“http//www.sec.co.kr” title=Samsung Electronics″>, the tag processor 220 separates a URL specified by the href attribute and a title specified by the title attribute in the <a> tag. That is, the controller 110 separates the URL “www.sec.co.kr” and the title “Samsung Electronics” from the <a> tag and tabulates them in the memory 140. The controller 110 also determines the format of the URL and stores the determined URL format in the memory 140. In the mean time, if the <a> tag does not include the title attribute, the controller 110 determines an Alt attribute value as the title attribute value. If there is not either of the Alt attribute and the title attribute in the <a> tag, the controller 110 determines the URL as the title attribute value. The resulting hyperlink list is shown in Table 1 below.

TABLE 1

| Title | URL | Format |
|---|---|---|
| Samsung Electronics | http://wap.sec.co.kr/index.htm | Web page |
| News moving picture | mms://wap/kbs.co.kr/news.wmv | multimedia |
| Product picture | http://wap.sec.co.kr/sch490.jpg | image |
| Web mail | http://wap.mail.samsung.com/ | e-mail |
| | a.sec?mailid=20 | |
| http://wap.sec.co.kr/cts.js | http://wap.sec.co.kr/cts.js | others |

In Table 1, ‘Title’ denotes a value specified by the title attribute of a hyperlink tag and ‘URL’ denotes a ULR in the hyperlink tag. ‘Format’ denotes the format of the URL. Others under ‘Format’ are the formats of an URL for which no format is explicitly specified. A hyperlink tag specifying http://wap.sec.co.kr/cts.js does not have either a title attribute or an Alt attribute and its URL is stored as a title value.

After creating the table with the hyperlink list, the controller 110 displays the hyperlink list on the display 120 in step 360.

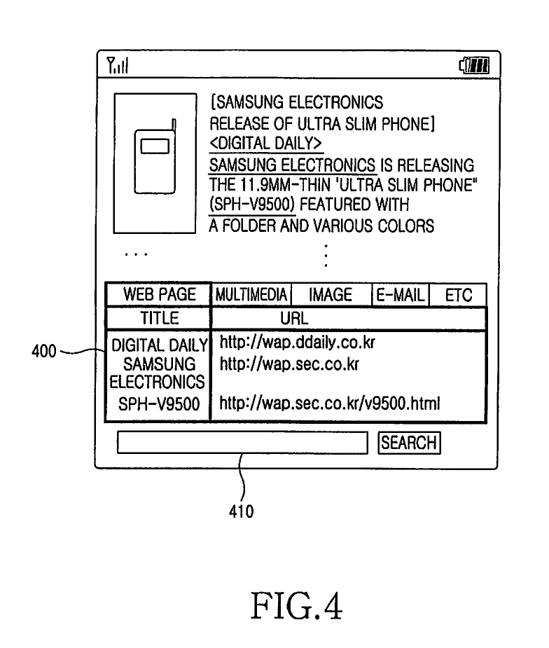

The hyperlink list is displayed as illustrated in FIG. 4. In FIG. 4, the hyperlink list at the bottom of a Web page is displayed on a URL format basis using tabs. The URL formats, i.e. Web page, multimedia, image, e-mail, and others are defined as tabs.

Upon key input for selecting one of the tabs from the user, a hyperlink list corresponding to the tab is output. The hyperlink list includes titles and URLs separately and the user can input a key that selects one of the titles. In accordance with an exemplary embodiment of the present invention, the user can move between the hyperlink list by up and down keys and between taps by left and right keys.

As further illustrated in FIG. 4, the user selects the tab corresponding to Web page and thus a hyperlink list 400 corresponding to Web page is displayed. The hyperlink list 400 may include a JavaScript hyperlink tag and a hyperlink tag with a hidden attribute.

It can be further contemplated as another exemplary embodiment of the present invention that a search window 410 is provided to enable the user to search for a hyperlink.

With the view of FIG. 4 displayed on the display 120, the controller 110 determines whether the user has selected a hyperlink in step 370. In the exemplary embodiment of the present invention, the controller 110 determines whether a hyperlink has been selected by checking whether a key corresponding to a title has been pressed. If the user has selected a hyperlink, the controller 110 access a URL corresponding to the selected hyperlink in step 380.

In addition, the controller 110 can overlay the hyperlink list and the contents of the accessed URL on the displayed Web page from which the hyperlinks have been detected, or display the hyperlink list and the contents of the accessed URL in a new window.

In this case, the mobile terminal automatically outputs hyperlinks included in a Web page so that the user can more efficiently and easily move over the wireless Internet. Also, the time taken for searching for a hyperlink is reduced, thereby decreasing the cost of using a communication network.

As described above, the present invention provides a method for detecting hyperlinks in a Web page and selecting a hyperlink in the wireless Internet in a mobile terminal. Therefore, a mobile terminal user can move between Web pages fast and easily. Further, since the mobile terminal enables the user to select a link hidden from a display, the user can enjoy the wireless Internet more conveniently through the mobile terminal than through a desktop computer.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for providing hyperlink information in a wireless Internet-enabled mobile terminal, the method comprising:
detecting hyperlink tags including access information from a Hyper Text Markup Language (HTML) source forming a Web page when accessing a wireless Internet;
extracting access information from each of the detected hyperlink tags;
generating a hyperlink list with the extracted access information; and
displaying the hyperlink list a display with the Web page displayed.

2. The method of claim 1, wherein the hyperlink tag detection comprises detecting one of a hyperlink tag used in JavaScript and a hyperlink tag with a hidden attribute.

3. The method of claim 1, wherein the access information extraction comprises separating a title and a Uniform Resource Locator (URL) from the each hyperlink tag.

4. The method of claim 3, wherein the hyperlink list generation comprises:
mapping a title to a URL each time access information is extracted; and
tabulating the mapped titles and URLs in the hyperlink list.

5. A mobile terminal for providing hyperlink information in a wireless Internet-enabled mobile terminal comprises:
a display for outputting a web page screen when accessing a wireless Internet;
a controller for detecting hyperlink tags including access information from a Hyper Text Markup Language (HTML) source, extracting the access information from each of the detected hyperlink tags, creating hyperlink list including the extracted access information and outputting the created hyperlink list on the display.

6. The mobile terminal of claim 5, further comprising a memory for storing the created hyperlink list.

7. The mobile terminal of claim 5, wherein the controller detects one hyperlink tag of hyperlink tag used in JavaScript and a hyperlink tag with a hidden attribute.

8. The mobile terminal of claim 5, wherein the controller separates a title and a Uniform Resource Locator (URL) from the each detected hyperlink tag.

9. The mobile terminal of claim 5, wherein the controller maps a title to a URL each time access information is extracted and tabulates the mapped titles and URLs in the hyperlink list.
